(19) United States
(12) Patent Application Publication
(10) Pub. No.: US 2010/0307312 A1
(43) Pub. Date: Dec. 9, 2010

(54) Counter-Die Band For The Cylinders of Rotary Die Cutting Machines

(76) Inventors: Ana B. Alonso Suarez, Torroso-Mos (ES); Maria J. Rey Stolle-Sanmartin, Torroso-Mos (ES)

Correspondence Address: COOK ALEX LTD, SUITE 2850, 200 WEST ADAMS STREET, CHICAGO, IL, 60606, US

(21) Appl. No.: 12/867,009

(22) PCT Filed: Feb. 12, 2009
(86) PCT No.: PCT/ES09/00084

§ 371 Date: Aug. 10, 2010

(30) Foreign Application Priority Data
Feb. 15, 2008 (ES) P 2008000409

(51) Int. Cl. B26D 7/20

(52) U.S. Cl. 83/698.42

(57) ABSTRACT

The rectangular counter-die band, (1) is provided that has corrugated edges (2) formed by alternating peaks (3) and valleys (4), designed such that, when mounted around the corresponding die cutting cylinder (8), the corrugated side edges (2) of the band determine lines of intersection with non-linear adjoining bands (1), thereby preventing the die cutting blades from cutting along said intersection lines. The band also includes corresponding end projections (5) comprising corresponding tongue-and-groove coupling recesses (6) and protrusions (7), both the band (1) and the projections (5) being made from polyurethane and being characterised in that the ends of the band (1) can be provided with projections (5′) having a corrugated outer profile formed by valleys (6′) and peaks (7′), thereby facilitating the intercoupling of the ends of the band (1).

### OBJECT OF THE INVENTION

This invention is related to a counter-die band designed so that it can be mounted around the cylinders of rotary die cutting machines, such band acting as a die to prevent the deterioration of the die-cutting blades.

The object of this invention is to prevent the appearance of the straight circumferential line determined between adjoining bands laid on the relevant cylinder.

### BACKGROUND OF THE INVENTION

Rotary die cutting machines comprise two cylinders, and the item to be die cut is inserted between them. One of the cylinders incorporates the die-cutting blades and the other one acts as the die-cutting base.

The cylinder that acts as a die-cutting base is made of steel and, in order to prevent the deterioration of the die-cutting blades during the die-cutting operation, the die-cut comprises a die made of a relatively soft material, usually polyurethane. The aforementioned die consists of a rectangular band that surrounds the cylinder, as a sort of cylindrical sleeve, and the ends of the said band or die incorporate metal profiles, or profiles made of the same polyurethane material that jointly form a sort of key that fits into a slot or key groove of the relevant cylinder, where such key is sometimes fastened by means of screws, and sometimes with different means.

One of the problems posed by said bands or dies is that, as they are perfectly rectangular, the line that determines the intersection with the adjoining bands sometimes coincides with the circular blade of the die, with the resulting die-cutting problem.

Another inconvenience is that the coupling ends of the band comprise tongue and groove elements, preferably following a dovetail pattern, which is difficult to assemble or couple, especially in those cases where the machine incorporates a closing mechanism at the cylinder key groove, that allows the opening and closing of such key groove to assemble and lock the band.

### DESCRIPTION OF THE INVENTION

The band of the invention, which is made of polyurethane, has side edges that are corrugated, instead of straight, which is the traditional case. Therefore, such edges will provide a broad corrugated edge, with two peaks and two valleys, with a height of some 20 mm. This corrugated edge prevents a straight circumferential line occurring at the intersection between adjoining bands, thus preventing the circular die cutting blades from cutting along said intersection lines.

On the other hand, it has also been foreseen that the band, apart from such corrugated sides, has also corrugated ends for the intercoupling with the relevant key groove of the cylinders so that, thanks to said corrugated arrangement of the ends, the band can be quickly and easily assembled. This solution is especially recommended in the case of those machines that incorporate a closing mechanism at the key groove of the cylinder, allowing the opening and closing of the cylinder to assemble and lock the band itself.

### DESCRIPTION OF THE DRAWINGS

To complement the description that is being made and with the object of assisting towards a better understanding of the characteristics of the invention, in accordance with a preferred example of practical embodiment thereof, a set of drawings is attached to said description as an integral part thereof, wherein, by way of illustration and without limitation, the following has been represented:

FIG. 1 shows a longitudinal view of a band made in accordance with the object of the invention, where its corrugated sides can be appreciated, as well as the ends incorporating the relevant polyurethane projections (keys) that determine the dovetail protrusions.

FIG. 2 shows a view of the layout of the different bands or dies mounted on the relevant die-cutting cylinder, where it can be appreciated that the intersection with the adjoining bands is not a straight line, thus preventing the circular die cutting blades from cutting along said intersection lines.

FIG. 3 shows a longitudinal view of a band similar to that of FIG. 1, with the peculiarity that, in this case, the profile of the polyurethane end projections, instead of consisting of valleys and peaks, forming a dovetail arrangement, show a corrugated profile, in order to facilitate the coupling of the said band.

### PREFERRED EMBODIMENT OF THE INVENTION

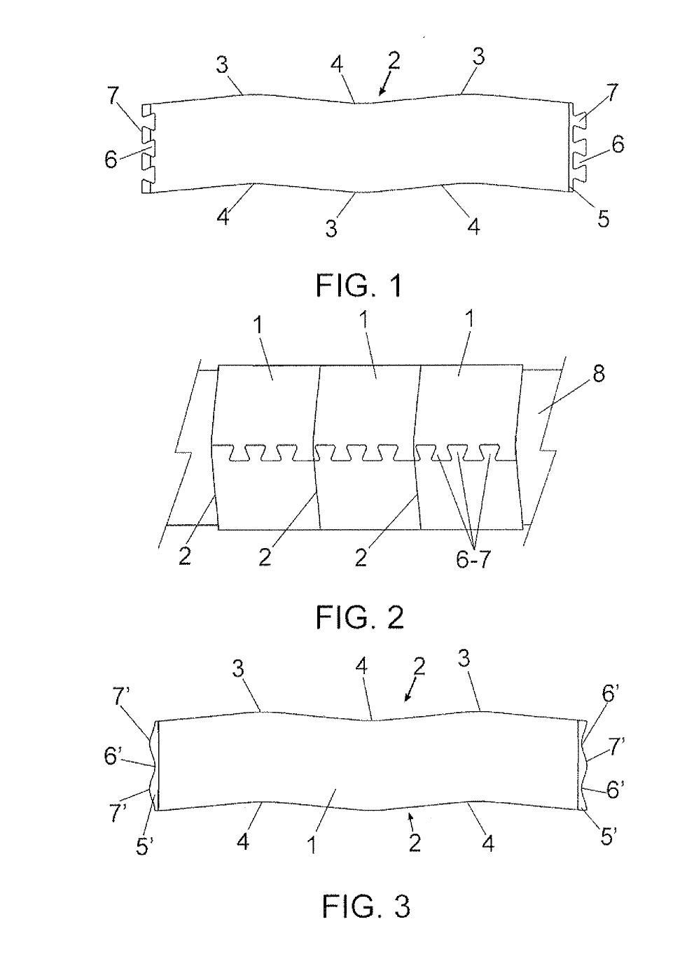

As it can be seen in the figures, especially in FIG. 1, the band (1) of the invention, conventionally consisting of a polyurethane material with glass fibre inside it to provide a greater consistency to the polyurethane material, shows the feature that the band has corrugated edges (2) following an undulated pattern, with two peaks (3) and two valleys (4), while the end projections (5), made of polyurethane, comprise complimentarily-shaped coupling recesses and protrusions (6 and 7) that facilitate the intercoupling means of the ends of the band (1), when the said band surrounds the relevant die cutting cylinder (8).

As it can be appreciated in FIG. 2, the arrangement of the bands or dies (1) around the cylinder (8), as a result of the corrugated profile (2) of its edges, determine that the lines of intersection with the adjoining bands (1) are not linear, thereby preventing the die cutting blades from cutting along said intersection lines of the bands (1), which occurs when said bands (1) are rectangular and comprise linear sides.

According to a variant embodiment shown in FIG. 3, the band (1) or die that is the object of the invention, apart from corrugated edges (2), comprises end projections (5′) having a corrugated outer profile formed by complementarily-shaped alternating valleys (6′) and peaks (7′), thereby facilitating the intercoupling of the ends of the band (1) with the relevant die cylinder (8).

1. A counter-die band for a cylinder of a rotary die cutting machine capable of being mounted around the cylinder where the cutting die acts to prevent the deterioration of the die-cutting blades, the band comprising a rectangular polyurethane element with complementarily-shaped end projections and recesses to facilitate the intercoupling of the band around the cylinder and the locking of said cylinder on the relevant key groove, the corrugated edges of the band having an undulated pattern consisting of alternating peaks and valleys so that the lines of intersection with adjoining bands around the cylinder that do not follow a linear circumferential pattern, thereby preventing the die cutting blades from cutting along said intersection lines while rotating.

2. A counter-die band for the cylinders of rotary die cutting machines according to claim 1, characterised in that the complementarily-shaped projections are tongue and groove projections that are reinforced by glass fibres.

3. A counter-die band for the cylinders of rotary die cutting machines, according to claim 1, characterised in that end projections have a corrugated outer profile formed by valleys and peaks, thereby facilitating the intercoupling of the ends of the band when such band is mounted on the relevant die cutting cylinder (8), such end projections being reinforced with glass fibres.
